(19) United States
(12) Patent Application Publication
(10) Pub. No.: US 2013/0082995 A1
(43) Pub. Date: Apr. 4, 2013

(54) DISPLAY, SOURCE DRIVER OF DISPLAY AND DRIVING METHOD THEREOF

(71) Applicants: Chun-Wei Hsieh, Hsinchu (TW); Sung-Kon Kim, Hsinchu (TW)

(72) Inventors: Chun-Wei Hsieh, Hsinchu (TW); Sung-Kon Kim, Hsinchu (TW)

(73) Assignee: E INK HOLDINGS INC., Hsinchu (TW)

(21) Appl. No.: 13/407,760

(22) Filed: Feb. 29, 2012

(30) Foreign Application Priority Data
Sep. 30, 2011 (TW) 100135545

(51) Int. Cl. G09G 5/00; G09G 3/34; G09G 3/36

(52) U.S. Cl. 345/208; 345/94; 345/107

(57) ABSTRACT

Disclosed herein are a display, a source driver of the display and a method for driving the same. The source driver includes a determining unit. The determining unit is configured to temporarily store data in response to a latch enable signal, to output a plurality of digital data values continuous in time sequence, and to sequentially convert a first digital data value and a second digital data value of the digital data values to a first analog signal and a second analog signal, respectively, and to compare the first digital data value with the second digital data value. When the first digital data value and the second digital data value are the same, the determining unit continuously outputs the first analog signal and the second analog signal.

### RELATED APPLICATIONS

This application claims priority to Taiwan Application Serial Number 100135545, filed Sep. 30, 2011, which is herein incorporated by reference.

### BACKGROUND

1. Technical Field

The present disclosure relates to a driver, and more particularly, a display, a source driver thereof and a driving method thereof.

2. Description of Related Art

An electrophoretic display (EPD) is a reflective display adopting principles of electrophoresis. EPDs operate using a display principle in which electric ions in transparent or colored liquid move, i.e., charged particles move toward an electrode having electric charges opposite to those of the charged particles in the electric field, such that pixels become light or dark by the turning over or flowing of microparticles.

Since electrophoretic displays possess the properties of paper and also provide electronic devices with the ability to update information, electrophoretic displays have been applied in portable electronic products such as electronic paper, e-books, electronic tags, etc.

During normal operation of an electrophoretic display, when a source driver outputs a voltage signal to a data line in the electrophoretic display, the source driver switches to output the voltage signal with a voltage level of 0 volts according to an output enable signal, in order to prevent the data line from being charged and discharged under the condition where the voltage of the data line is transited with a too large voltage difference.

However, always switching the output voltage signal to have a voltage level of 0 volts results in unnecessary charging and discharging, and the operation of the source driver outputting signals according to the output enable signal should be fully adopted, and such control should not be performed on a partial basis or performed a single time.

Therefore, it would be advantageous to solve the above problems.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Therefore, the present invention provides a display and a source driver thereof to solve problems of unnecessary charging and discharging and instantaneous large current.

One embodiment of the present invention relates to a source driver of a display, and the source driver of the display includes a determining unit. The determining unit is configured to receive a plurality of digital data values according to a latch enable signal, to sequentially convert a first digital data value and a second digital data value of the digital data values, which are continuous in time sequence, to a first analog signal and a second analog signal, respectively, and to compare the first digital data value with the second digital data value. When the first digital data value and the second digital data value are the same, the determining unit continuously outputs the first analog signal and the second analog signal.

The other embodiment of the present invention provides a display which includes a driving substrate, an opposite substrate and a display layer. The driving substrate includes a source driver that includes a determining unit. The determining unit is configured to receive a plurality of digital data values according to a latch enable signal, to sequentially convert a first digital data value and a second digital data value of the digital data values, which are continuous in time sequence, to a first analog signal and a second analog signal, respectively, and to compare the first digital data value with the second digital data value. The display layer is disposed between the driving substrate and the opposite substrate. When the first digital data value and the second digital data value are the same, the determining unit continuously outputs the first analog signal and the second analog signal.

Another embodiment of the present invention provides a driving method of a source driver of a display. The method includes the following steps: receiving a plurality of digital data values according to a latch enable signal; sequentially converting a first digital data value and a second digital data value of the digital data values, which are continuous in time sequence, to a first analog signal and a second analog signal, respectively; comparing the first digital data value and the second digital data value; and continuously outputting the first analog signal and the second analog signal when the first digital data value and the second digital data value are the same.

Therefore, the embodiments of the present invention reduce the impact of instantaneous large current by comparing digital data values that are continuous in time sequence to choose the best output option and solve the problem of unnecessary charging and discharging.

### BRIEF DESCRIPTION OF THE DRAWINGS

The present invention can be more fully understood by reading the following detailed description of the embodiments, with reference made to the accompanying drawings as follows:

FIG. 1 is a diagram of a source driver of a display according to an embodiment of the present invention.

FIG. 2 is a signal waveform diagram according to the embodiment of FIG. 1.

FIG. 3 is a diagram of a logic circuit in a decoding circuit of FIG. 1.

FIG. 4 is a flow chart of a driving method of a source driver of a display according to an embodiment of the present invention.

FIG. 5a and FIG. 5b are diagrams of conversion of frames.

FIG. 6 is a block diagram of a display according to an embodiment of the present invention.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a,” “an,” and “the” includes reference to the plural unless the context clearly dictates otherwise. Also, as used in the description herein and throughout the claims that follow, the terms “comprise or comprising,” “include or including,” “have or having,” “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

From one or many aspects, the present disclosure relates to a source driver and a driving method of the same. The mechanism may be applied to current electrophoretic displays and may be adaptable to relative technologies.

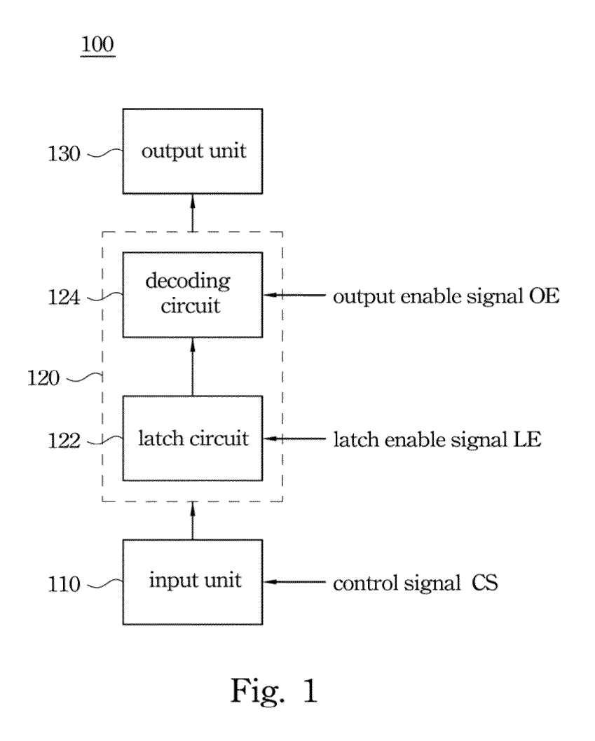

FIG. 1 is a diagram illustrating a source driver 100 applied in a display according to an embodiment of the present invention. The source driver 100 includes a determining unit 120. The display may be an electrophoretic display or a display based on other related technologies.

The determining unit 120 is configured to receive digital data values according to a latch enable signal LE, to sequentially convert a first digital data value and a second digital data value of the digital data values, which are continuous in time sequence, to a first analog signal and a second analog signal, respectively, and to compare the first digital data value with the second digital data value. When the first digital data value and the second digital data value are the same, the determining unit 120 continuously outputs the first analog signal and the second analog signal.

In one embodiment, the determining unit 120 includes a latch circuit 122 and a decoding circuit 124, in which the decoding circuit 124 is coupled to the latch circuit 122 and processes signals outputted from the latch circuit 122.

The latch circuit 122 has a latch function to receive digital data values according to the latch enable signal LE, and outputs a plurality of digital data values that are continuous in time sequence. The latch circuit 122 receives the digital data values when the latch enable signal LE is at a high logic state, and the latch circuit 122 transmits the digital data values to the decoding circuit 124 when the latch enable signal LE is at a low logic state.

The decoding circuit 124 is configured to receive the first digital data value and the second digital data value of the digital data values, which are continuous in time sequence, from the latch circuit 122, to sequentially convert the first digital data value and the second digital data value to the first analog signal and the second analog signal, respectively, and to compare the first digital data value with the second digital data value. The decoding circuit 124 outputs signals in different outputting modes based upon the comparison results.

More specifically, when the first digital data value and the second digital data value are the same, the decoding circuit 124 continuously outputs the first analog signal and the second analog signal. When the first digital data value and the second digital data value are different and an output enable signal OE is at a low logic state, the decoding circuit 124 outputs a middle analog signal between the first analog signal and the second analog signal according to the output enable signal OE. The comparing function/operation mentioned above is performed such that the source driver 100 can operate under the best outputting mode so as to save power and increase the charging efficiency of a thin film transistor and/or capacitor therein.

In another embodiment, when the first digital data value and the second digital data value are different, the first analog signal may be a positive voltage signal or a negative voltage signal, the second analog signal may be a negative voltage signal or a positive voltage signal that is opposite to the first analog signal, and the middle analog signal may be a zero voltage signal (i.e., a voltage signal with a voltage level of 0 volts). For example, if the first analog signal has a voltage level of +5 volts, the second analog signal has a voltage level of −5 volts.

In yet another embodiment, the source driver 100 further includes an input unit 110 and an output unit 130. The input unit 110 is coupled to the determining unit 120 and configured to temporarily store and output a plurality of digital data values continuous in time sequence according to a control signal (CS). The input unit 110 may include a register (not shown) and a direction control logic circuit (not shown) according to an embodiment. Detailed functions of these two elements of the input unit 110 are well known by those skilled in the art and can be obtained easily, and therefore are not described herein.

The output unit 130 is coupled to the determining unit 120 and configured to sequentially convert the first analog signal and the second analog signal to output a first relatively high level analog signal and a second relatively high level analog signal. In one embodiment, the output unit 130 includes a voltage level shifter (not shown) and an output buffer circuit (not shown). The detailed functions of these two elements of the output unit 130 are well known by those skilled in the art and can be obtained easily, and therefore are not described herein. The voltage level of the first relatively high level analog signal is higher than the voltage level of the first analog signal, and the voltage level of the second relatively high level analog signal is higher than the voltage level of the second analog signal. For example, if each of the first relatively high level analog signal and the second relatively high level analog signal has a voltage level of +15 volts, each of the first analog signal and the second analog signal has a voltage level of +5 volts.

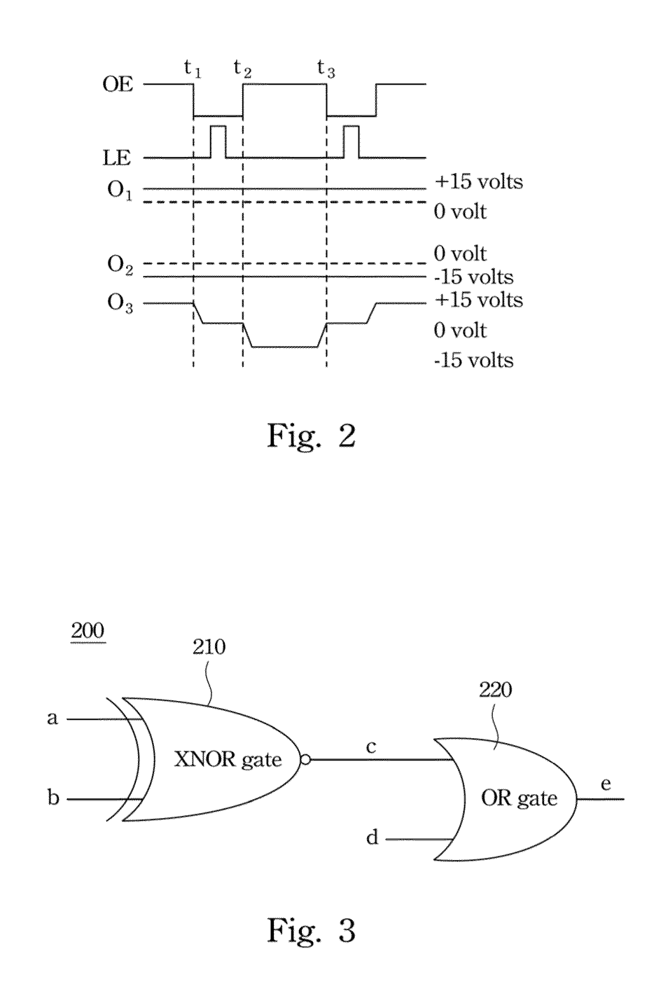

FIG. 2 is a waveform diagram showing operation of the source driver in FIG. 1 according to one embodiment of the present invention. Referring to both FIG. 1 and FIG. 2, in one embodiment, the decoding circuit 124 sequentially receives the first digital data value and the second digital data value and compares the first digital data value with the second digital data value. When these two digital data values are the same, the decoding circuit 124 continuously outputs the first analog signal and the second analog signal without outputting the middle analog signal (e.g., a voltage signal with a voltage level of 0 volts) between these two analog signals, so that the output unit 130 sequentially converts the first analog signal and the second analog signal and outputs a continuous output signal O1, in which the output signal O1 can be, for example, a relatively high level analog signal with a voltage level of +15 volts through time t1, t2 and t3. In another embodiment, when the first digital data value and the second digital data value are the same, the first relatively high level analog signal and the second relatively high level analog signal both have a voltage level of −15 volts. Therefore the output unit 130 continuously outputs an output signal O2 with a voltage level of −15 volts. Details in this regard have already been described above and will not be repeated.

On the other hand, when the first digital data value and the second digital data value are different, the decoding circuit 124 outputs the middle analog signal (e.g., a voltage signal with a voltage level of 0 volts) between the first analog signal and the second analog signal when the output enable (OE) signal is at a low logic state. The output unit 130 converts the first analog signal, the middle analog signal and the second analog signal, and then outputs an output signal O3. The output signal O3 is a first relatively high level analog signal (i.e., a voltage signal with a voltage level of +15 volts) before time t1, and the output signal O3 is a second relatively high level analog signal between time t2 and t3 (i.e., a voltage signal with a voltage level of −15 volts). Since the first relatively high level analog signal and the second relatively high level analog signal are different, the output signal O3 has a voltage level of 0 volts between time t1 and t2, i.e., a 0-volt voltage signal. The source driver chooses the best outputting mode by comparing the digital data values to reduce unnecessary charging and discharging.

Referring to FIG. 3, a diagram of a logic circuit 200 in the decoding circuit 124 in FIG. 1 is illustrated. According to an embodiment of the present invention, the decoding circuit 124 includes the logic circuit 200 configured to compare the first digital data value with the second digital data value which are continuous in time sequence, to determine the optimized outputting result of the source driver. The logic circuit 200 includes an XNOR gate 210 and an OR gate 220. The XNOR gate 210 includes a first input and a second input. The first input is configured to receive the first digital data value a, and the second input is configured to receive the consecutive second digital data value b. The OR gate 220 includes a third input and a fourth input. The third input is coupled to an output of the XNOR gate 210 and receives a signal c, and the fourth input is configured to receive a signal d, in which the signal d is the output enable signal OE. The output of the OR gate 220 is configured for outputting a signal e.

A truth table for the XNOR gate 210 is shown below as Table 1, and a truth table for the OR 220 is shown below as Table 2.

TABLE 2

| | signal | | |
|---|---|---|---|
| | c | d | e |
| logic | 0 | 0 | 0 |
| value | 0 | 1 | 1 |
| | 1 | 0 | 1 |
| | 1 | 1 | 1 |

TABLE 1

| | signal | | |
|---|---|---|---|
| | a | b | c |
| logic | 0 | 0 | 1 |
| value | 0 | 1 | 0 |
| | 1 | 0 | 0 |
| | 1 | 1 | 1 |

From Table 1 and Table 2, when the first digital data value a and the second digital data value b are the same, the logic value of the output signal c outputted from the XNOR gate 210 is 1. At this time, the logic value of the signal d (i.e., output enable signal OE) does not influence the signal e, so that the output enable signal OE has no effect. Therefore the decoding circuit 124 continuously outputs the same voltage signal such that the output unit 130 likewise continuously outputs the same voltage signal.

On the other hand, when the first digital data value a and the second digital data value b are different, the logic value of the signal c outputted from the XNOR gate 210 is 0. At this time, the signal d (i.e., the output enable signal OE) influences the signal e. Therefore the output enable signal OE has an effect, such that the decoding circuit 124 switches to output the voltage signal with a voltage level of 0 volts between the first and the second analog signals according to the output enable signal OE, and furthermore, the output of the output unit 130 is switched to have a voltage level of 0 volts according to the output enable signal OE. The latch circuit 122 is switched depending on the latch enable signal LE. By applying the logic circuit 200 in the decoding circuit 124, the decoding circuit 124 can perform a comparing function and/or operation. According to another embodiment of the present invention, the decoding circuit 124 may further include a register circuit for performing the comparing function and/or operation.

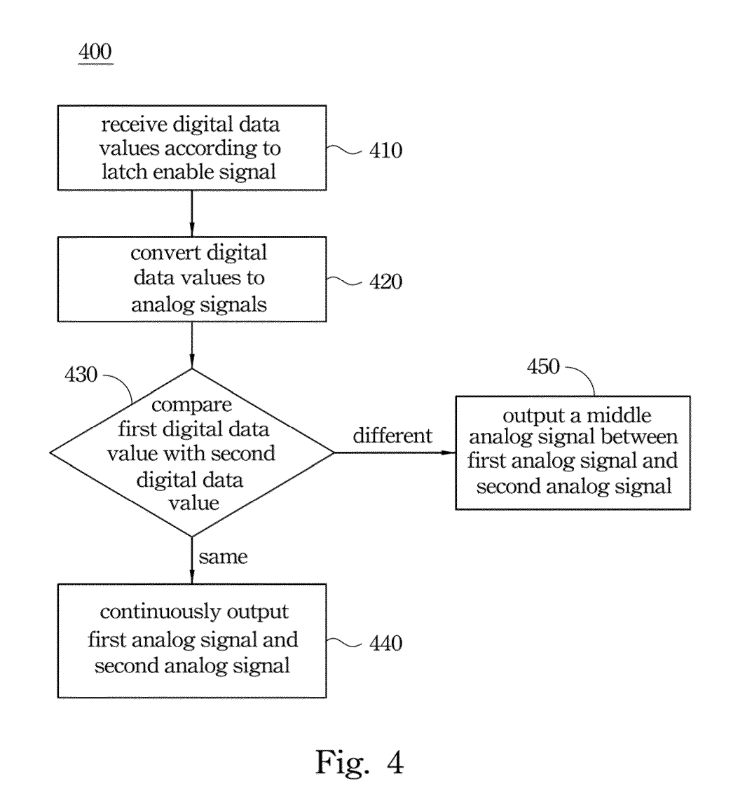

FIG. 4 is a flow chart of a driving method 400 of a source driver of a display according to an embodiment of the present invention. It should be noted that except for steps described as being in a specific order, the order of the steps in the present embodiment may be changed, and even all or some of the steps may be performed simultaneously. In addition, the hardware for executing the method 400 has been disclosed in the foregoing embodiment and is thus not described again.

Referring to FIG. 4, a plurality of digital data values continuous in time sequence are received according to a latch enable signal LE (S410). Next, a first digital data value and a second digital data value of the digital data values, which are continuous in time sequence, are sequentially converted to a first analog signal and a second analog signal, respectively (S420). Subsequently, the first digital data value is compared with the second digital data value (S430). When the first digital data value and the second digital data value are the same, the first analog signal and the second analog signal are continuously outputted (S440), and this is referred to as the continuous output mode.

According to an embodiment of the present invention, the method further includes a step S450, in which a middle analog signal is outputted between the first analog signal and the second analog signal according to the output enable signal OE when the first digital data value and the second digital data value are different, and this is referred to as the two-stage output mode

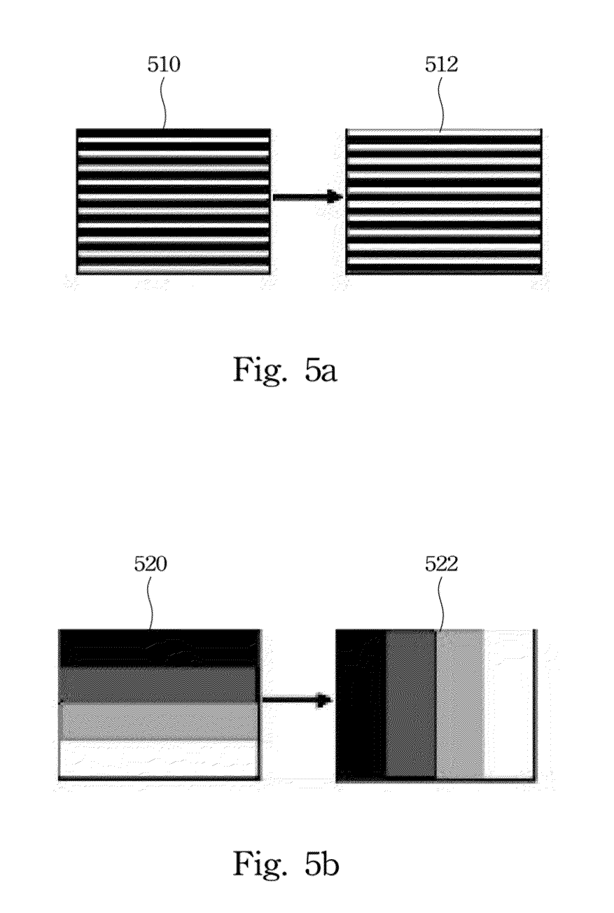

FIG. 5a and FIG. 5b are diagrams of conversion of frames. As shown in FIG. 5a, all output voltages of the source driver are changed when a frame 510 is converted to a frame 512. As shown in FIG. 5b, only some output voltages of the source driver are changed when a frame 520 is converted to a frame 522. The two different converting modes for the two different frames of test current are tested, and the experimental results are shown in Table 3.

TABLE 3

| | two-stage output | | continuous output | |
|---|---|---|---|---|
| | Frame | | | |
| | frame of | frame of FIG. | frame of FIG. | frame of |
| | FIG. 5a | 5b | 5a | FIG. 5b |
| power | 782.0803 | 525.175 | 915.03832 | 204.96314 |
| consumption | | | | |
| (mW) | | | | |

From Table 3, when the converting mode is the two-stage output mode, power consumptions of the frames in FIG. 5a and FIG. 5b are 782.0803 mW and 525.175 mW, respectively, and when the converting mode is the continuous output mode, power consumptions of the frames in FIG. 5a and FIG. 5b are 915.03832 mW and 204.96314 mW, respectively. From the experimental values mentioned above, it is evident that the power consumption of the frame in FIG. 5b is lower in the continuous output mode and the power consumption of the frame in FIG. 5a is lower in the two-stage output mode. Therefore, the optimized outputting mode of a frame can be found by the method mentioned above to save power and achieve the best power efficiency.

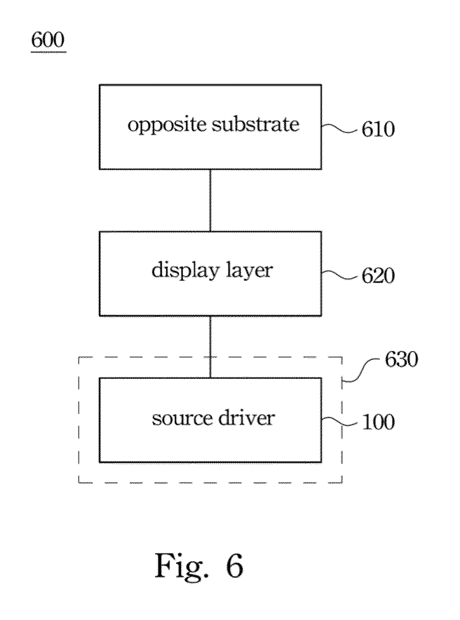

Referring to FIG. 6, a block diagram of a display is illustrated according to an embodiment of the present invention. The display 600 includes an opposite substrate 610, a display layer 620, and a driving substrate 630. The driving substrate 630 includes a source driver 635 corresponding to the source driver 100 of FIG. 1. The display layer 620 is disposed between the driving substrate 630 and the opposite substrate 610. In practice, the opposite substrate 610 may be a color filter having a plurality of color filter units or may be composed of an upper substrate and a color filter film.

In one embodiment, the display layer 620 is an electrophoretic display layer of a capsule-type electrophoretic display or a liquid crystal layer of a liquid crystal display. In another embodiment, the liquid crystal display includes a backlight module (not shown) for providing a light source.

In conclusion, the determining function is achievable by adding an uncomplicated logic circuit or a register circuit into a data register originally existing in an integrated circuit of the source driver. By comparing the last outputting state with the present outputting state to determine whether to adjust the voltage, the best outputting mode can be chosen and power consumption resulting from unnecessary charging and discharging can be reduced. Hence, the charging efficiency of a thin film transistor and/or capacitor can be increased.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A source driver adapted for a display, comprising:
a determining unit for receiving a plurality of digital data values according to a latch enable signal, sequentially converting a first digital data value and a second digital data value of the digital data values to a first analog signal and a second analog signal, respectively, and comparing the first digital data value with the second digital data value, wherein the first digital data value and the second digital data value are continuous in time sequence;
wherein the determining unit continuously outputs the first analog signal and the second analog signal when the first digital data value and the second digital data value are the same.

2. The source driver of claim 1, wherein the determining unit comprises:
is a latch circuit for temporarily storing and outputting the digital data values according to the latch enable signal; and
a decoding circuit coupled to the latch circuit, for sequentially converting the first digital data value and the second digital data value of the digital data values, which are continuous in time sequence, to the first analog signal and the second analog signal, respectively, and comparing the first digital data value with the second digital data value, wherein the decoding circuit continuously outputs the first analog signal and the second analog signal when the first digital data value and the second digital data value are the same.

3. The source driver of claim 2, wherein the decoding circuit outputs a middle analog signal between the first analog signal and the second analog signal according to an output enable signal when the first digital data value and the second digital data value are different;
wherein a voltage level of the middle analog signal is set between a voltage level of the first analog signal and a voltage level of the second analog signal.

4. The source driver of claim 3, wherein the middle analog signal is a zero voltage signal.

5. The source driver of claim 3, wherein the decoding circuit comprises:
an exclusive NOR gate comprising a first input and a second input, wherein the first input is configured to receive the first digital data value and the second input is configured to receive the second digital data value and
an OR gate comprising a third input and a fourth input, wherein the third input is coupled to an output of the exclusive NOR gate and the fourth input is configured to receive the output enable signal.

6. The source driver of claim 1, further comprising:
an input unit coupled to the determining unit, for temporarily storing a plurality of digital data values continuous in time sequence according to a control signal; and
an output unit coupled to the determining unit, for sequentially converting the first analog data value and the second analog data value to continuously output a first relatively high level analog signal and a second relatively high level analog signal;
wherein a voltage level of the first relatively high level analog signal is higher than a voltage level of the first analog signal, and a voltage level of the second relatively high level analog signal is higher than a voltage level of the second analog signal.

7. A display comprising:
a driving substrate comprising a source driver, wherein the source driver comprises:
a determining unit for receiving a plurality of digital data values according to a latch enable signal, sequentially converting a first digital data value and a second digital data value of the digital data values, which are continuous in time sequence, to a first analog signal and a second analog signal, respectively, and comparing the first digital data value and the second digital data value;
an opposite substrate; and
a display layer disposed between the driving substrate and the opposite substrate;
wherein the determining unit continuously outputs the first analog signal and the second analog signal when the first digital data value and the second digital data value are the same.

8. The display of claim 7, wherein the display layer is an electrophoresis display layer of a capsule-type electrophoretic display or a liquid crystal layer of a liquid crystal display.

9. The display of claim 8, wherein the liquid crystal display comprises a backlight module for providing a light source.

10. A driving method adapted for a source driver of a display, comprising:
receiving a plurality of digital data values according to a latch enable signal;
sequentially converting a first digital data value and a second digital data value of the digital data values, which are continuous in time sequence, to a first analog signal and a second analog signal, respectively;
comparing the first digital data value with the second digital data value; and
continuously outputting the first analog signal and the second analog signal when the first digital data value and the second digital data value are the same.

11. The driving method of claim 10, further comprising:
outputting a middle analog signal between the first analog signal and the second analog signal according to an output enable signal when the first digital data value and the second digital data value are different.
